(19) United States
(12) Patent Application Publication
(10) Pub. No.: US 2011/0084821 A1
(43) Pub. Date: Apr. 14, 2011

(54) LUMINOUS ALERTING DEVICE

(76) Inventor: Johnson Li, Taichung Hsien (TW)

(21) Appl. No.: 12/575,472

(22) Filed: Oct. 8, 2009

(51) Int. Cl. B62J 6/00

(52) U.S. Cl. 340/432

(57) ABSTRACT

A luminous alerting device includes two connecting portions, two illuminating units detachably attached to the two connecting portions for adapting to be mounted on an outfit, and a wireless controller wirelessly communicated with the two illuminating units for controlling illuminating of the two illuminating units.

### BACKGROUND OF THE INVENTION

1. Field of the Invention

The present invention relates to an alerting device, and more particularly to a luminous alerting device adapted to outfits of cyclists for providing an alerting function when cycling.

2. Description of Related Art

A conventional alerting device for cyclists in accordance with the prior art comprises a control panel, a controlling unit and an illuminating unit disposed on an outer surface of an outfit. The illuminating unit is circuitly connected to the controlling unit. The controlling unit wirelessly communicates with the control panel, and is adapted to receive wireless signals sent from the control panel such that the cyclists can use the control panel to control the illuminating and blinking of the illuminating unit to alert the passing vehicles. However, the conventional alerting unit bears several defects. As the illuminating unit is an electronic device, the disposition of the illuminating unit on the outer surface of the outfit makes the outfit unsuitable to be washed or laundered. Since cycling is an intensive activity which results in heavy perspiration of the cyclists, an outfit designed unsuitable to be washed/laundered is disadvantageous and lacks functionality.

In addition, due to the illuminating unit fixedly disposed on the outfit, the illuminating unit can not be freely detached from the outfit and/or applied to different outfits; the cyclists have to purchase several alerting devices for adapting to different outfits in order for replacement and to adapt to different weather conditions, which is not economical from a cost-evaluation aspect. Nevertheless, the illuminating unit fixedly attached to an outfit refrains users from freely changing and replacing the illuminating unit at his/her desire.

The present invention has arisen to obviate/ mitigate the disadvantages of the conventional alerting device for cyclists.

### SUMMARY OF THE INVENTION

The present invention relates to a luminous alerting device which comprises two connecting portions, two illuminating units detachably attached to the two connecting portions for adapting to be mounted on an outfit, a wireless controller wirelessly communicated with the two illuminating units for controlling illuminating of the two illuminating units, and a fixing portion connected to the wireless controller for fastening the wireless controller with a bicycle handle. Each connecting portion has a first portion and a second portion respectively attached to the illuminating unit and the outfit. The first portion and the second portion respectively are a male adhesive piece and a female adhesive piece. The male adhesive piece is detachably affixed to the female adhesive piece for attaching the illuminating unit to the outfit. Each illuminating unit includes a lighting device which has a light cover mounted thereto. The light cover has a transparent pattern formed thereon such that when the illuminating unit is illuminated, light is projected through the transparent pattern of the light cover for providing a patterned illumination. Two directional buttons are disposed on the wireless controller for respectively controlling illumination of the two illuminating units. When one of the directional buttons is pushed, the wireless controller wirelessly sends out signals to a corresponding illuminating unit such that the corresponding illuminating unit is illuminated and the turning direction is signaled. An alerting button is disposed on the wireless controller. When the alerting button is pushed, the wireless controller wirelessly sends out signals to the two illuminating units such that the two illuminating units are illuminated simultaneously for providing an alerting function.

In accordance with a second aspect of the present invention, the first portion and the second portion respectively are a male buckle and a female buckle. The male buckle is detachably buckled to the female buckle for attaching the illuminating unit to the outfit.

In accordance with a third aspect of the present invention, each connecting portion is a transparent pocket which has an opening defined in a top thereof for detachably receiving the illuminating unit. Each transparent pocket has a plurality of holes defined in an outer surface thereof for dissipating the heat from the illuminating unit detachably received in the transparent pocket.

In accordance with a fourth aspect of the present invention, each illuminating unit is in an arrow-shape.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the luminous alerting device in accordance with the present invention;

FIG. 2 is a partial exploded perspective view of the luminous alerting device in accordance with the present invention for showing a connecting portion;

FIG. 3 is an exploded perspective view of the illuminating unit of the luminous alerting device in accordance with the present invention;

FIG. 4 is a perspective view of the two illuminating units of the luminous alerting device in accordance with the present invention disposed on an outfit;

FIG. 5 is a plane view of the two illuminating units of the luminous alerting device in accordance with the present invention disposed on the outfit;

FIG. 6 is an operational perspective view of the luminous alerting device in accordance with the present invention, showing that one of the illuminated units in an illuminated state;

FIG. 7 is an operational perspective view of the luminous alerting device in accordance with the present invention;

FIG. 8 is a partial exploded perspective view of a second embodiment of the luminous alerting device in accordance with the present invention;

FIG. 9 is a plane view of a third embodiment of the luminous device in accordance with the present invention; and

FIG. 10 is a plane view of a fourth embodiment of the luminous device in accordance with the present invention.

### DETAILED DESCRIPTION OF THE INVENTION

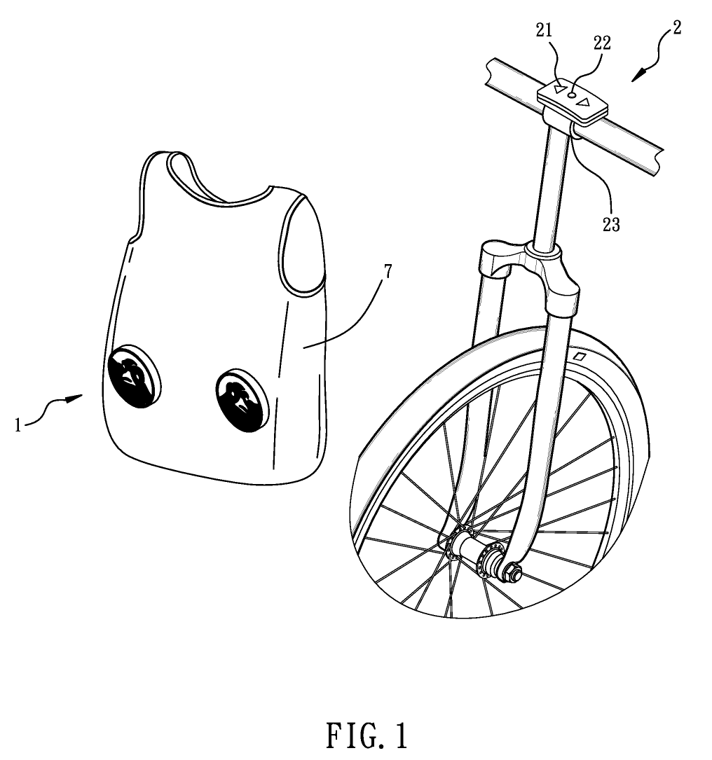

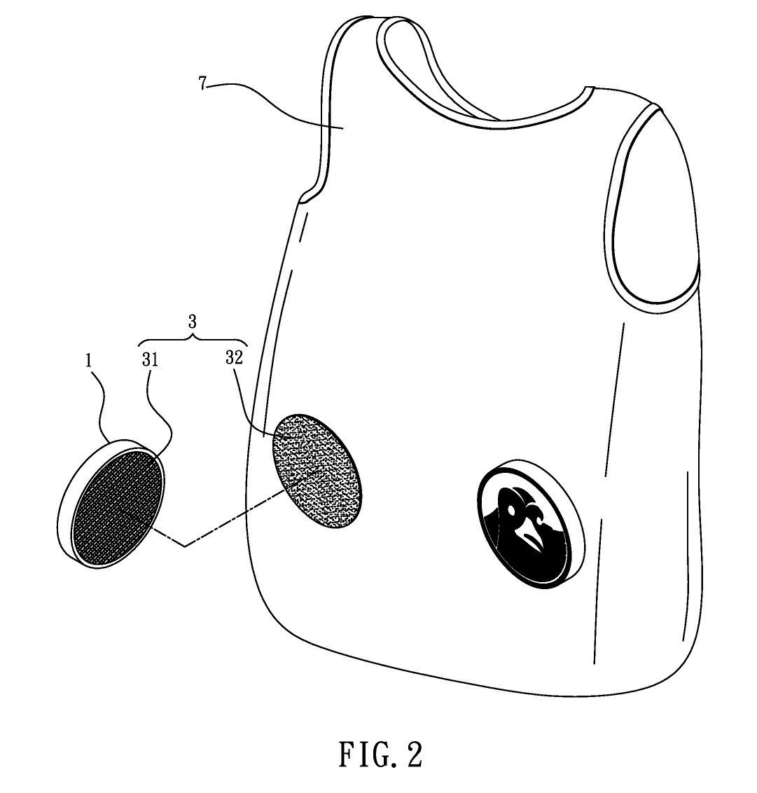

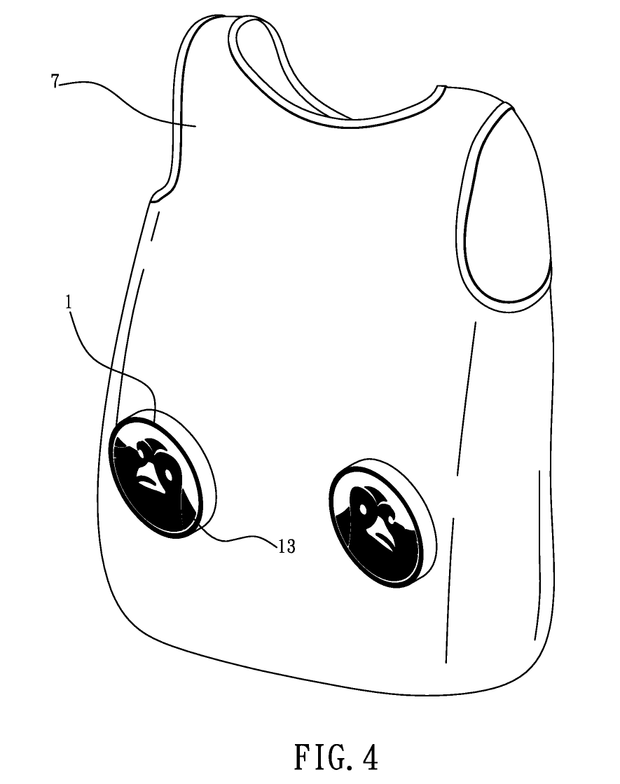

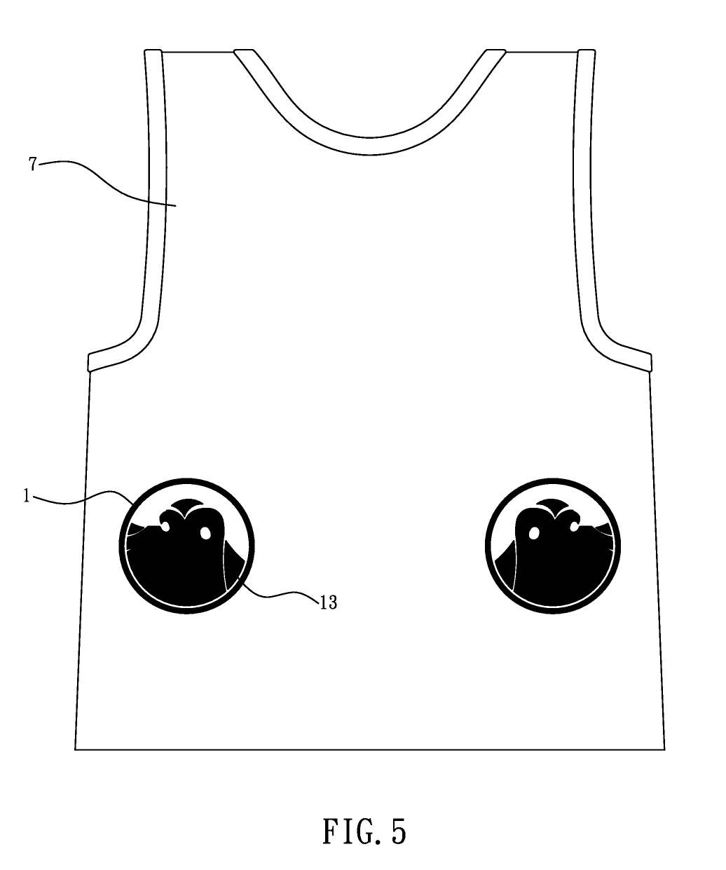

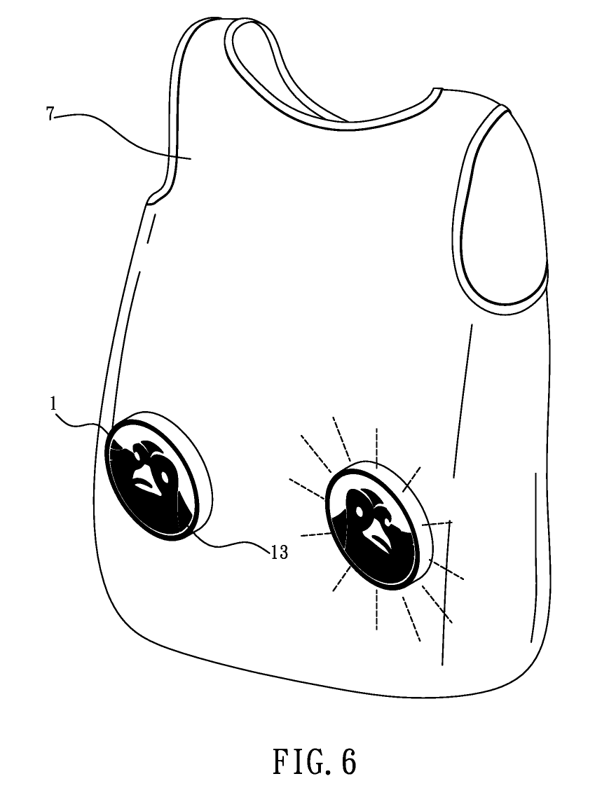

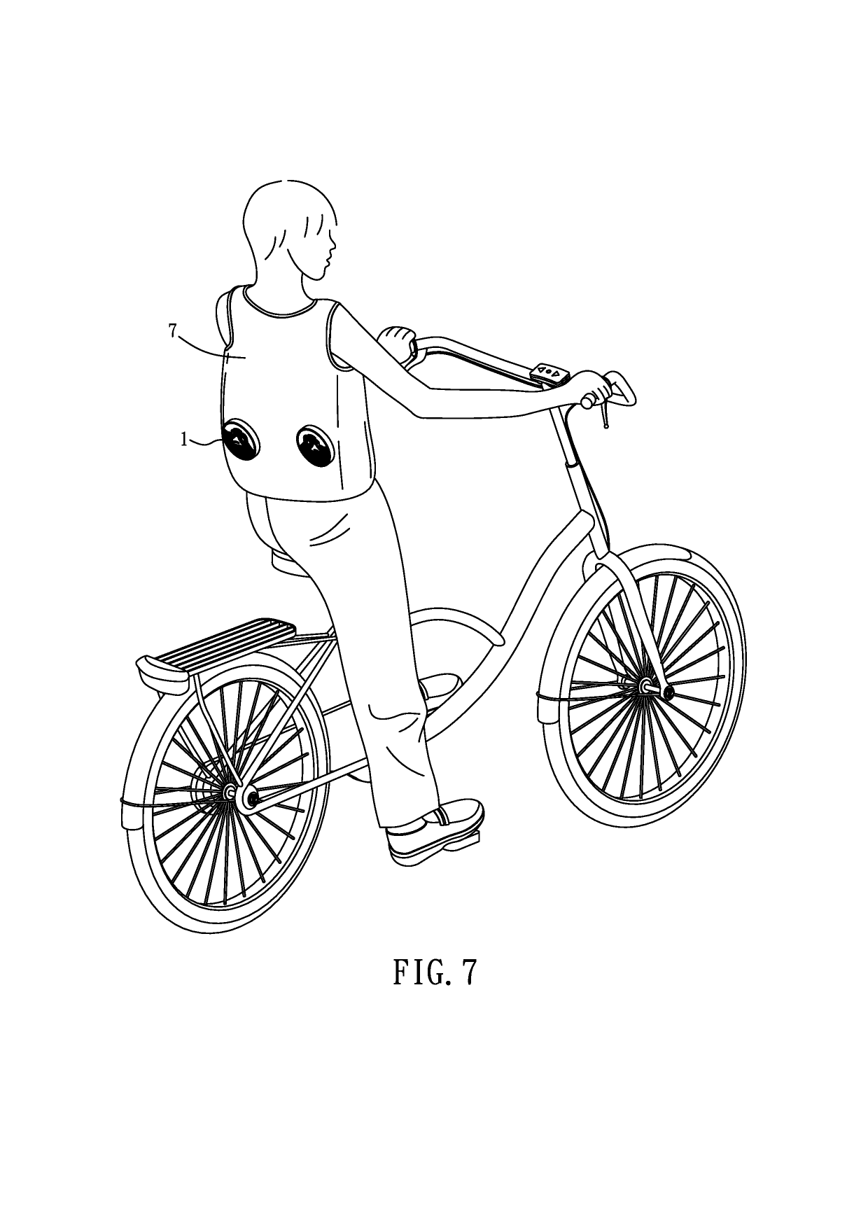

Referring to the drawings and initially to FIGS. 1-7, a luminous alerting device in accordance with the present invention comprises two connecting portions 3, two illuminating units 1 detachably attached to the two connecting portions 3 for adapting to be mounted on an outer surface of an outfit 7, and a wireless controller 2 wirelessly communicated with the two illuminating units 1 for controlling illumination of the two illuminating units 1. Two directional buttons 21 are disposed on two ends of the wireless controller 2 for respectively controlling illumination of the two illuminating units 1. When one of the directional buttons 21 is pushed, the wireless controller 2 wirelessly sends out signals to a corresponding illuminating unit 1 such that the corresponding illuminating unit 1 is illuminated or blinked, distinctively signaling the turning direction for allowing passing vehicles or pedestrians to easily identify a moving direction of the bicycle, hence enhancing the safety of the cyclists when riding. An alerting button 22 is disposed on the wireless controller 2. When the alerting button 22 is pushed, the wireless controller 2 wirelessly sends out signals to the two illuminating units 1 such that the two illuminating units 1 are simultaneously illuminated or blinked to continuously provide an alerting function. The wireless controller 2 is also adapted for co-operating with a bicycle breaking system (not shown) such that when braking, the two illuminating units 1 are functioned as break lights, corresponded to the braking motion and illuminated simultaneously. A fixing portion 23 is connected to the wireless controller 2 for fastening the wireless controller 2 with a bicycle handle (not numbered).

Each connecting portion has a first portion 31 and a second portion 32 respectively attached to a back of the illuminating unit 1 and the outer surface of the outfit 7. The first portion 31 and the second portion 32 are respectively a male adhesive piece and a female adhesive piece (i.e. Velcro pads). The male adhesive piece is detachably affixed to the female adhesive piece for attaching the illuminating unit 1 to the outfit 7 such that the illuminating unit 1 is easily attached to or detached from the outfit 7 for allowing a user to freely detach the illuminating unit 1 from the outfit 7 at his/her desire.

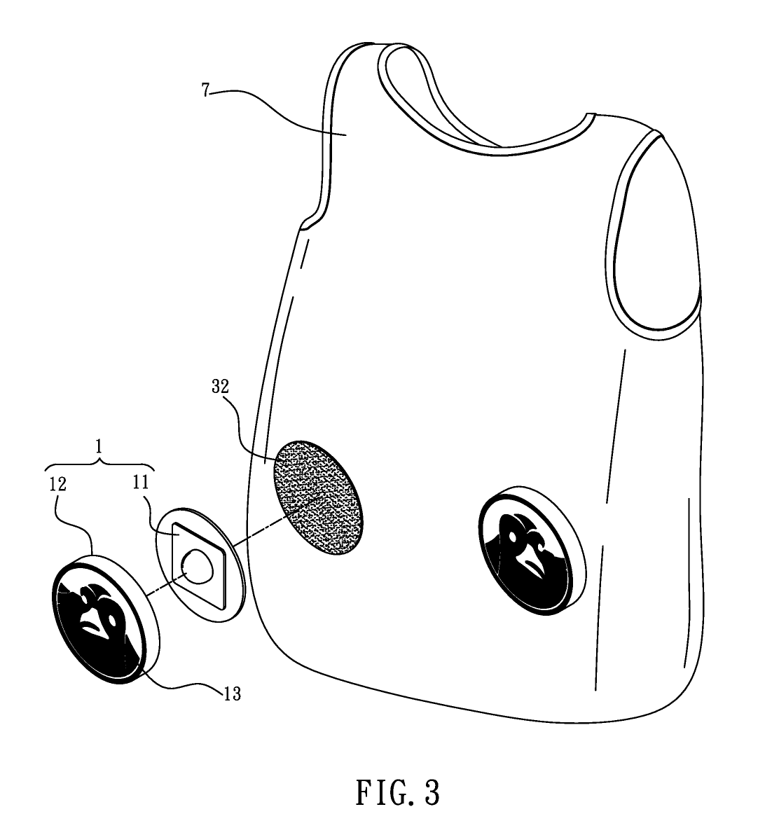

Referring to FIG. 3, each of the illuminating unit 1 in accordance with the present invention includes a lighting device 11 which has a light cover 12 mounted thereto. The light cover 12 has a transparent pattern 13 formed thereon such that when the illuminating unit 1 is illuminated, light is projected through the transparent pattern 13 of the light cover 12, providing a patterned illumination to enhance visual effect of the illuminating unit 1. In this embodiment, the transparent pattern 13 is an image of a magpie.

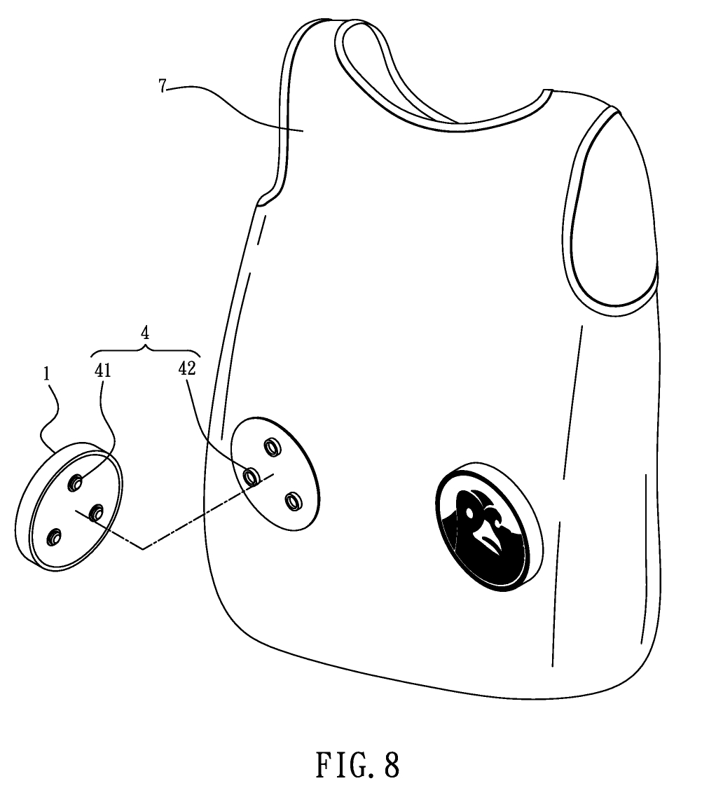

With reference to FIG. 8, that shows a second embodiment of the luminous alerting device in accordance with the present invention. The elements and effects of the second embodiment which are the same with the first embodiment are not described, only the differences are described. In this embodiment, each connecting portion 4 has a first portion 41 and a second portion 42 respectively attached to the illuminating unit 1 and the outfit 7. The first portion 41 and the second portion 42 are respectively a plurality of male buckles and a plurality of female buckles. The plurality of male buckles are detachably buckled to the plurality of female buckles for attaching the illuminating unit 1 to the outfit 7.

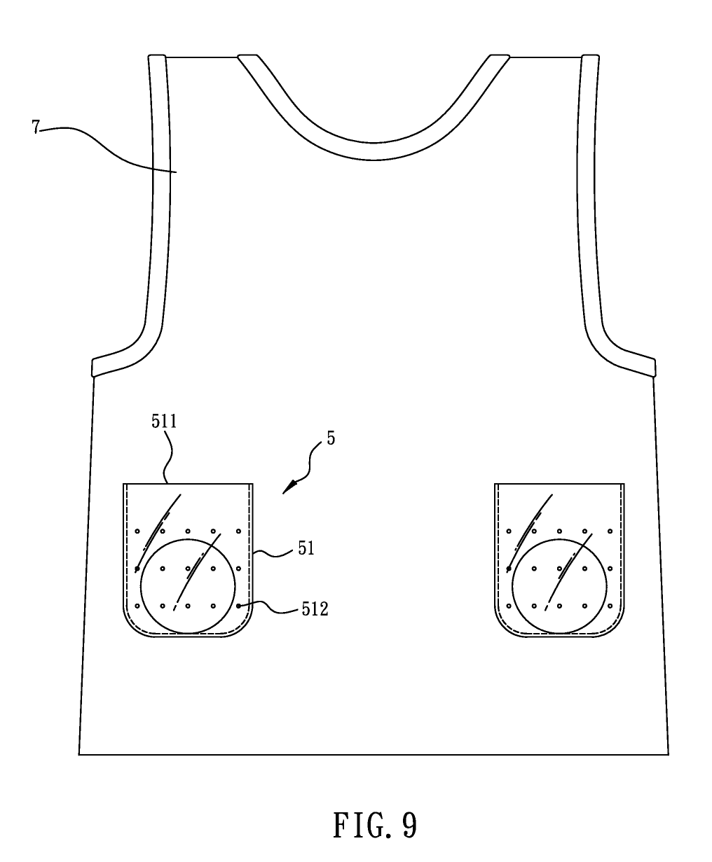

With reference to FIG. 9, that shows a third embodiment of the luminous alerting device in accordance with the present invention. The elements and effects of the third embodiment which are the same with the first embodiment are not described, only the differences are described. In this embodiment, each connecting portion 5 is a transparent pocket 51 which has an opening 511 defined in a top thereof for detachably receiving the illuminating unit 1. Each transparent pocket 51 is stitchingly secured to a surface of the outfit 7. Each transparent pocket 51 has a plurality of holes 512 defined therein for dissipating the heat from the illuminating unit 1 received in the transparent pocket 51 and preventing the illuminating unit 1 from overheating due to illuminating.

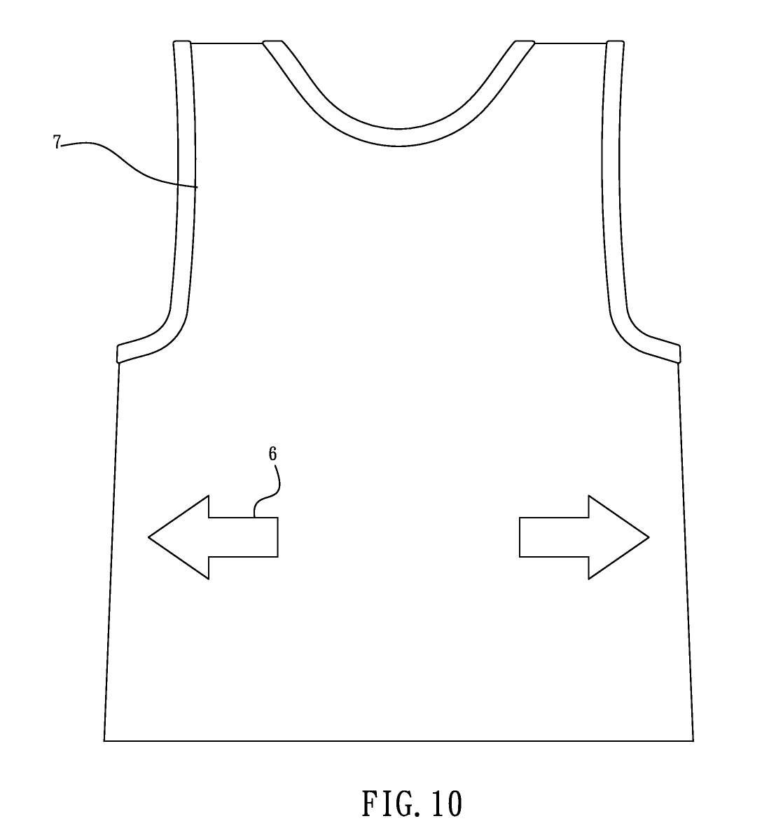

With reference to FIG. 10, that shows a fourth embodiment of the luminous alerting device in accordance with the present invention. The elements and effects of the fourth embodiment which are the same with the first embodiment are not described, only the differences are described. In this embodiment, each illuminating unit 6 is in an arrow shape for providing more distinct indication of turning direction when the two illuminating units 6 co-operate with the directional buttons 21 and signal turning direction. A first illuminating unit 6 is in the arrow shape indicating to a left side. A second illuminating unit 6 is in the arrow shape indicating to a right side.

Although the invention has been explained in relations to its preferred embodiment, it is to be understood that many other possible modifications and variations can be made without departing from the spirit and scope of the invention as hereinafter claimed.

What is claimed is:

1. A luminous alerting device comprising:
two connecting portions;
two illuminating units detachably attached to the two connecting portions for adapting to be mounted on an outfit; and
a wireless controller wirelessly communicated with the two illuminating units for controlling illumination of the two illuminating units.

2. The luminous alerting device as claimed in claim 1, further comprising two directional buttons disposed on the wireless controller for respectively controlling illumination of the two illuminating units;
wherein when one of the directional button is pushed, the wireless controller wirelessly sends out signals to a corresponding illuminating unit such that the corresponding illuminating unit is illuminated and the turning direction is signaled.

3. The luminous alerting device as claimed in claim 1, further comprising an alerting button disposed on the wireless controller;
wherein when the alerting button is pushed, the wireless controller wirelessly sends out signals to the two illuminating units such that the two illuminating units simultaneously illuminated for providing an alerting function.

4. The luminous alerting device as claimed in claim 1, wherein each connecting portion having a first portion and a second portion respectively attached to the illuminating unit and the outfit; the first portion and the second portion respectively being a male adhesive piece and a female adhesive piece;
wherein the male adhesive piece is detachably affixed to the female adhesive piece for attaching the illuminating unit to the outfit.

5. The luminous alerting device as claimed in claim 1, wherein each connecting portion having a first portion and a second portion respectively attached to the illuminating unit and the outfit; the first portion and the second portion respectively being a male buckle and a female buckle;
wherein the male buckle is detachably buckled to the female buckle for attaching the illuminating unit to the outfit.

6. The luminous alerting device as claimed in claim 1, wherein each connecting portion being a transparent pocket having an opening defined in a top thereof for detachably receiving the illuminating unit.

7. The luminous alerting device as claimed in claim 6, wherein each transparent pocket having a plurality of holes defined on an outer surface thereof for dissipating the heat from the illuminating unit detachably received in the transparent pocket.

8. The luminous alerting device as claimed in claim 1, wherein each illuminating unit including a lighting device having a light cover mounted thereto, the light cover having a transparent pattern formed thereon such that when the illuminating unit illuminated, light is projected through the transparent pattern of the light cover providing a patterned illumination.

9. The luminous alerting device as claimed in claim 1, wherein each illuminating units is in an arrow-shape.

10. The luminous alerting device as claimed in claim 1, further comprising a fixing portion connected to the wireless controller for fastening the wireless controller with a bicycle handle.
